(19) United States
(12) Patent Application Publication
(10) Pub. No.: US 2026/0338919 A1
(43) Pub. Date: Oct. 29, 2026

(54) RADAR AND DETECTION DEVICE

(71) Applicant: SUTENG INNOVATION TECHNOILOGY CO., LTD, Shenzhen (CN)

(72) Inventors: Deguo Li, Shenzhen (CN); Xin Zhao, Shenzhen (CN)

(73) Assignee: SUTENG INNOVATION TECHNOILOGY CO., LTD, Shenzhen (CN)

(21) Appl. No.: 19/438,435

(22) Filed: Dec. 31, 2025

(30) Foreign Application Priority Data
Jan. 7, 2025 (CN) 202510028213.3

(51) Int. Cl. G01S 7/481

(52) U.S. Cl. CPC G01S 7/4813

(57) ABSTRACT

A radar and a detection device are provided. The radar includes a lens barrel and an optical module. The lens barrel is provided with a positioning portion. The optical module includes an optical component, a structural member, and an adhesive member. The structural member is provided with a positioning hole. The positioning portion is inserted into the positioning hole. The adhesive member is filled between an inner wall of the positioning hole and an outer wall of the positioning portion to fixedly adhere them. The optical component is disposed on a side of the structural member facing the lens barrel. The cooperation between the positioning portion and the positioning hole facilitates active and precise positioning of the optical module relative to an optical lens module disposed on the lens barrel for optical alignment.

### CROSS REFERENCE TO RELATED APPLICATION

The present application claims the benefit of priority to Chinese Patent Application No. 202510028213.3, filed on Jan. 7, 2025, which is hereby incorporated by reference in its entirety.

### TECHNICAL FIELD

Embodiments of the present invention relate to the technical field of radar, and in particular, to a radar and a detection device.

### BACKGROUND

A lidar is a device that detects the distance, shape, and environmental features of a target by emitting laser pulses and measuring their time of return or intensity.

Generally, a lidar includes a housing, an emission module, an emission lens module, a reception module, a reception lens module, and a main control module. Among them, the housing serves as the mounting base for the other structures within the lidar. The emission module includes an emission circuit board and a light source disposed thereon, and is used to generate detection light, which exits the lidar via the emission lens module to detect a target object. The reception module includes a reception circuit board and a photodetection module disposed thereon; the detection light is reflected by the target object to form echo light, which is directed toward the reception module via the reception lens to achieve reception of the echo light. The main control module is communicatively connected to the emission module and the reception module, respectively, to control the operation of the emission module and the reception module.

During the assembly of the emission lens module with the emission module, as well as the assembly of the reception lens module with the reception module, it is necessary to align the emission module/reception module with the emission lens module/reception lens module. Since the required positioning accuracy exceeds the manufacturing precision of the structures themselves, active and precise positioning is required to achieve optical alignment. However, the current structure of lidars is not conducive to such positioning of the emission module/reception module.

### SUMMARY

Embodiments of the present invention aim to provide a radar and a detection device, which can overcome the above-mentioned problems or at least partially solve them.

To address the above technical problem, a technical solution adopted by the embodiments of the present invention is: A radar, comprising a lens barrel and an optical module; the lens barrel is provided with a positioning portion; the optical module comprises an optical component, a structural member, and an adhesive member, the structural member is provided with a positioning hole, the positioning portion is inserted into the positioning hole, the adhesive member is filled between an inner wall of the positioning hole and an outer wall of the positioning portion, the adhesive member fixedly adheres the inner wall of the positioning hole and the outer wall of the positioning portion, and the optical component is disposed on a side of the structural member facing the lens barrel.

Optionally, along a first direction, a cross-sectional area of the positioning portion gradually decreases, and a cross-section of the positioning portion is a cross-section of the positioning portion along a second direction; wherein the first direction is a direction from the optical component towards the structural member, and the second direction is perpendicular to the first direction.

Optionally, along the first direction, a cross-sectional area of the positioning hole gradually decreases, and a cross-section of the positioning hole is a cross-section of the positioning hole along the second direction.

Optionally, along the first direction, the positioning portion has a first taper, the positioning hole has a second taper, and the first taper is equal to the second taper.

Optionally, a side of the structural member facing away from the optical component is provided with a recess, the positioning hole communicates with a bottom of the recess, and a portion of the positioning portion extending out of the positioning hole along the first direction is received in the recess; wherein the first direction is a direction from the optical component towards the structural member.

Optionally, a depth of the recess is greater than a height of the portion of the positioning portion extending out of the positioning hole.

Optionally, along the first direction, a cross-sectional area of at least a part of the recess gradually increases, and a cross-section of the recess is a cross-section of the recess along the second direction, the second direction being perpendicular to the first direction.

Optionally, the recess comprises a first groove section and a second groove section, the first groove section, the second groove section, and the positioning hole communicate sequentially, and along the first direction, a cross-sectional area of the first groove section gradually increases, a cross-section of the first groove section being a cross-section of the first groove section along the second direction.

Optionally, the outer wall of the positioning portion is provided with a first laser-engraved surface, the first laser-engraved surface is provided with a plurality of first laser-engraved grooves, and one side of the adhesive member is at least partially embedded in the plurality of first laser-engraved grooves; and/or, the inner wall of the positioning hole is provided with a second laser-engraved surface, the second laser-engraved surface is provided with a plurality of second laser-engraved grooves, and another side of the adhesive member is at least partially embedded in the plurality of second laser-engraved grooves.

Optionally, a side of the structural member facing the lens barrel is provided with a protruding portion, the positioning hole penetrates the protruding portion, the optical component is provided with an avoidance hole, and the protruding portion is inserted into the avoidance hole.

Optionally, the optical component comprises an optical mainboard, an optical chip, a light-shielding member, and a filter member, the optical mainboard is disposed on the side of the structural member facing the lens barrel, the optical chip is disposed on a side of the optical mainboard facing the lens barrel, the light-shielding member is mounted to cover the optical chip, the light-shielding member is provided with a light-transmitting hole, the filter member is disposed in the light-transmitting hole, and the avoidance hole is provided in the optical mainboard.

Optionally, a height of the protruding portion is greater than a thickness of the optical mainboard.

Optionally, a material of the lens barrel and a material of the structural member are both metallic materials.

Optionally, the structural member is a heat dissipation member, and the optical module is an emission module or a reception module.

To address the above technical problem, another technical solution adopted by the embodiments of the present invention is: providing a detection device, comprising the radar described above.

Beneficial effects of the embodiments of the present invention are: Different from the prior art, the embodiments of the present invention provide a radar comprising a lens barrel and an optical module; the lens barrel is provided with a positioning portion; the optical module comprises an optical component, a structural member, and an adhesive member, the structural member is provided with a positioning hole, the positioning portion is inserted into the positioning hole, the adhesive member is filled between an inner wall of the positioning hole and an outer wall of the positioning portion, the adhesive member fixedly adheres the inner wall of the positioning hole and the outer wall of the positioning portion, and the optical component is disposed on a side of the structural member facing the lens barrel. In the above manner, the cooperation between the positioning portion and the positioning hole in the embodiments of the present invention can facilitate active and precise positioning of the optical module relative to an optical lens module disposed on the lens barrel to complete optical alignment.

### BRIEF DESCRIPTION OF DRAWINGS

In order to more clearly illustrate the technical solutions in the specific embodiments of the present invention or the prior art, the drawings required for describing the specific embodiments or the prior art will be briefly introduced below. In all the drawings, similar elements or parts are generally identified by similar reference numerals. In the drawings, the elements or parts are not necessarily drawn to scale.

FIG. 1 is an overall structural schematic view of a radar provided by an embodiment of the present invention;

FIG. 2 is an overall exploded view of the radar provided by an embodiment of the present invention;

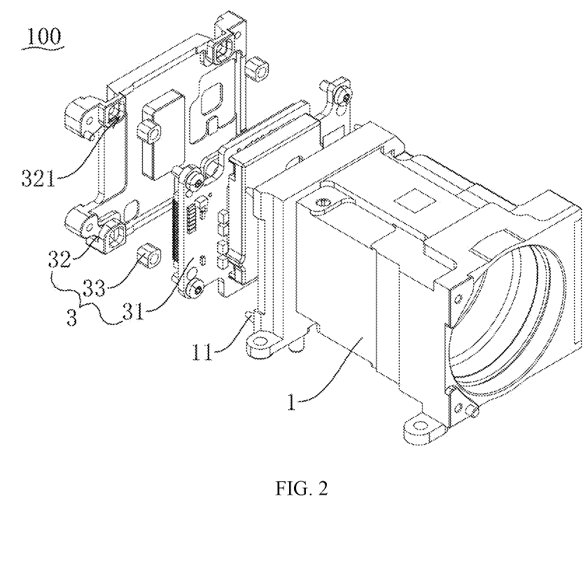

FIG. 3 is an overall cross-sectional view of the radar provided by an embodiment of the present invention;

FIG. 4 is a first schematic structural view of a positioning portion and a positioning hole of the radar provided by an embodiment of the present invention;

FIG. 5 is a second schematic structural view of the positioning portion and the positioning hole of the radar provided by an embodiment of the present invention;

FIG. 6 is a third schematic structural view of the positioning portion and the positioning hole of the radar provided by an embodiment of the present invention;

FIG. 7 is a first schematic structural view of a part of the radar provided by an embodiment of the present invention;

FIG. 8 is a second schematic structural view of a part of the radar provided by an embodiment of the present invention;

FIG. 9 is a third schematic structural view of a part of the radar provided by an embodiment of the present invention.

### REFERENCE NUMERALS

1 lens barrel,
11 positioning portion,
12 emission board structural assembly,
121 light exit hole,
122 heat dissipation boss,
123 isolation boss;
3 optical module,
31 optical component,
311 avoidance hole,
312 optical mainboard,
313 optical chip,
314 light-shielding member,
3141 light-transmitting hole,
315 filter member,
32 structural member,
321 positioning hole,
322 recess,
3221 first groove section,
3222 second groove section,
323 protruding portion,
33 adhesive member;
100 radar;
X first direction,
Y second direction.

### DETAILED DESCRIPTION

To facilitate the understanding of the present invention, the present invention is described in more detail below with reference to the accompanying drawings and specific embodiments. It should be noted that when an element is described as being "fixed on" another element, it can be directly on the other element, or there may be one or more intervening elements. When an element is described as being "connected" to another element, it can be directly connected to the other element, or there may be one or more intervening elements. The orientation or positional relationships indicated by terms such as "upper", "lower", "inner", "outer", "vertical", "horizontal", etc., used in this specification are based on the orientation or positional relationships shown in the accompanying drawings. They are only for the convenience of describing the present invention and simplifying the description, rather than indicating or implying that the referred apparatus or element must have a specific orientation or be constructed and operated in a specific orientation. Therefore, they should not be construed as limiting the present invention. Furthermore, terms such as "first" and "second" are used for descriptive purposes only and should not be understood as indicating or implying relative importance.

Unless otherwise defined, all technical and scientific terms used in this specification have the same meanings as commonly understood by those skilled in the technical field to which the present invention belongs. The terms used in the specification of the present invention herein are for the purpose of describing specific embodiments only and are not intended to limit the present invention. The term "and/or" used in this specification includes any and all combinations of one or more of the associated listed items.

A lidar is a device that detects the distance, shape, and environmental features of a target by emitting laser pulses and measuring their time of return or intensity.

Generally, a lidar includes a housing, an emission module, an emission lens module, a reception module, a reception lens module, and a main control module. Among them, the housing serves as the mounting base for the other structures within the lidar. The emission module includes an emission circuit board and a light source disposed thereon, and is used to generate detection light, which exits the lidar via the emission lens module to detect a target object. The reception module includes a reception circuit board and a photodetection module disposed thereon; the detection light is reflected by the target object to form echo light, which is directed toward the reception module via the reception lens to achieve reception of the echo light. The main control module is communicatively connected to the emission module and the reception module, respectively, to control the operation of the emission module and the reception module.

During the assembly of the emission lens module with the emission module, as well as the assembly of the reception lens module with the reception module, it is necessary to align the emission module/reception module with the emission lens module/reception lens module. Since the required positioning accuracy exceeds the manufacturing precision of the structures themselves, active and precise positioning is required to achieve optical alignment. However, the current structure of lidars is not conducive to such positioning of the emission module/reception module.

In view of this, the present invention provides an embodiment of a radar 100, which can facilitate active and precise positioning of an optical module 3 relative to an optical lens module disposed on a lens barrel 1 to complete optical alignment.

To facilitate the reader's understanding of the concept of the embodiments of the present invention, the specific structure of the radar 100 is described below:

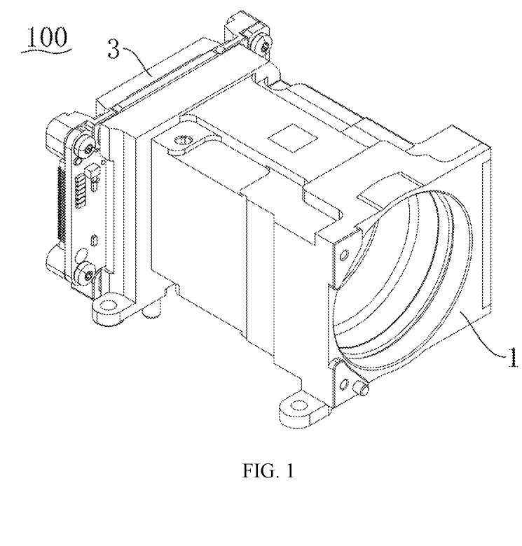

Please refer to FIGS. 1 - 4. The radar 100 comprises a lens barrel 1 and an optical module 3. The lens barrel 1 is provided with a positioning portion 11. The optical module 3 comprises an optical component 31, a structural member 32, and an adhesive member 33. The structural member 32 is provided with a positioning hole 321. The positioning portion 11 is inserted into the positioning hole 321. The adhesive member 33 is filled between an inner wall of the positioning hole 321 and an outer wall of the positioning portion 11. The adhesive member 33 fixedly adheres the inner wall of the positioning hole 321 and the outer wall of the positioning portion 11. The optical component 31 is disposed on a side of the structural member 32 facing the lens barrel 1. It can be understood that the optical component 31 comprises an emission optical component or a reception optical component. The lens barrel 1 comprises an emission lens barrel and a reception lens barrel. The emission optical component corresponds to an emission optical lens provided with the emission lens barrel, and the reception optical component corresponds to a reception optical lens provided with the reception lens barrel.

Specifically, the structural member 32 is plate-shaped and comprises a first part and a second part having different thicknesses. The thickness of the first part is greater than that of the second part. The positioning hole 321 is provided in the first part, thereby increasing the depth of the positioning hole 321. This further increases the height of the adhesive member 33 filled between the positioning portion 11 and the positioning hole 321, improves the stability between the positioning portion 11 and the positioning hole 321, and thus enhances the stability between the optical module 3 and the lens barrel 1.

In the above manner, the cooperation between the positioning portion 11 and the positioning hole 321 facilitates active and precise positioning of the optical module 3 relative to the optical lens module disposed on the lens barrel 1 to complete optical alignment.

In some embodiments, the radar comprises a housing. The structural member 32 is disposed between the lens barrel 1 and the housing. The structural member 32 can be used to improve the stability between the lens barrel 1 and the housing, thereby enhancing the stability of the optical component 31.

In some embodiments, the structural member 32 is a heat dissipation member. Heat generated during the operation of the optical component 31 is transferred to the heat dissipation member for dissipation, which helps improve the heat dissipation efficiency of the optical module 3.

In some embodiments, the optical module 3 is an emission module, or the optical module 3 is a reception module.

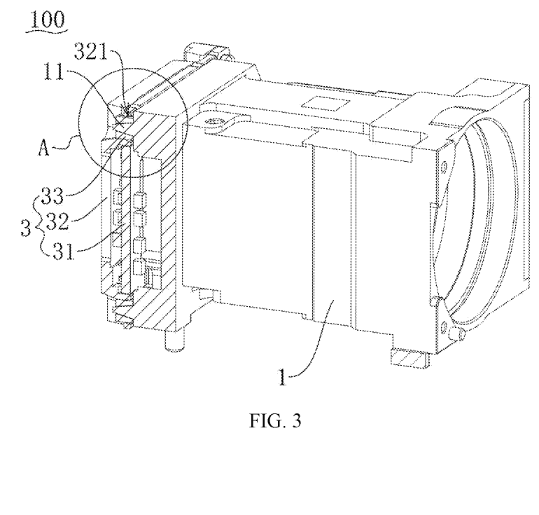

Regarding the positioning portion 11, please refer to FIGS. 3 - 5. Along a first direction X, a cross-sectional area of the positioning portion 11 gradually decreases. A cross-section of the positioning portion 11 is a cross-section of the positioning portion 11 along a second direction Y. The first direction X is a direction from the optical component 31 towards the structural member 32, and the second direction Y is perpendicular to the first direction X.

In the above manner, the positioning portion 11 is configured as a conical column. This not only increases the surface area of the outer wall of the positioning portion 11, thereby increasing the bonding area between the positioning portion 11 and the adhesive member 33 to improve the bonding firmness, but also enhances the rigidity of the positioning portion 11.

Regarding the positioning hole 321, please refer to FIGS. 3 - 5. Along the first direction X, a cross-sectional area of the positioning hole 321 gradually decreases. A cross-section of the positioning hole 321 is a cross-section of the positioning hole 321 along the second direction Y.

In the above manner, the positioning hole 321 has a conical structure, which increases the surface area of the inner wall of the positioning hole 321, thereby increasing the bonding area between the positioning hole 321 and the adhesive member 33 and improving the bonding firmness.

Regarding the positioning portion 11 and the positioning hole 321, please refer to FIGS. 3 - 5. Along the first direction X, the positioning portion 11 has a first taper, the positioning hole 321 has a second taper, and the first taper is equal to the second taper.

In the above manner, the uniformity of the thickness of the adhesive member 33 filled between the positioning portion 11 and the positioning hole 321 is improved, avoiding local excessive thickness or thinness of the adhesive member 33 that could affect its firmness.

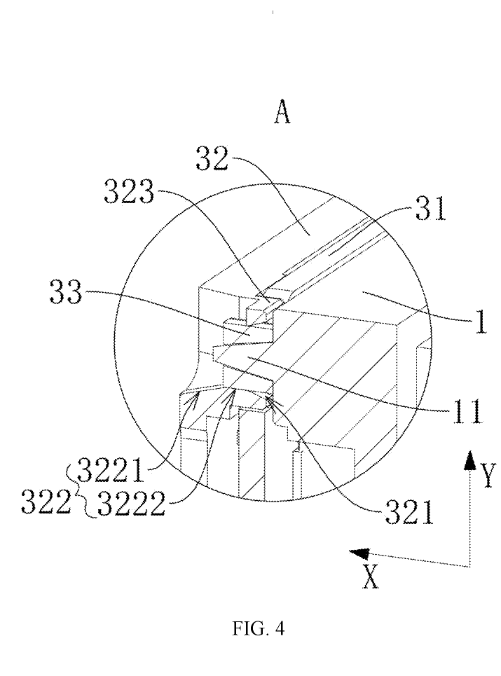

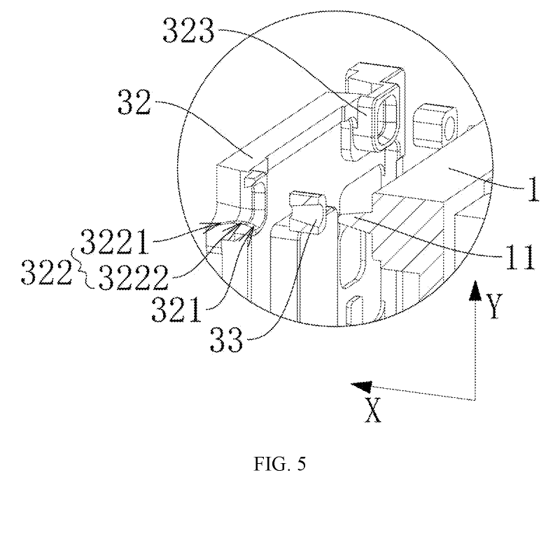

Regarding the positioning portion 11 and the positioning hole 321, please refer to FIGS. 4 and 5. The outer wall of the positioning portion 11 is provided with a first laser-engraved surface. The first laser-engraved surface is provided with a plurality of first laser-engraved grooves. One side of the adhesive member 33 is at least partially embedded in the plurality of first laser-engraved grooves; and/or, the inner wall of the positioning hole 321 is provided with a second laser-engraved surface. The second laser-engraved surface is provided with a plurality of second laser-engraved grooves. Another side of the adhesive member 33 is at least partially embedded in the plurality of second laser-engraved grooves.

In the above manner, the first laser-engraved surface and the second laser-engraved surface are both uneven surfaces. The plurality of first laser-engraved grooves and the plurality of second laser-engraved grooves are grooves of varying depths, which can enhance the bonding force between the adhesive member 33 and the outer wall of the positioning portion 11 and the inner wall of the positioning hole 321, respectively, thereby improving the bonding firmness.

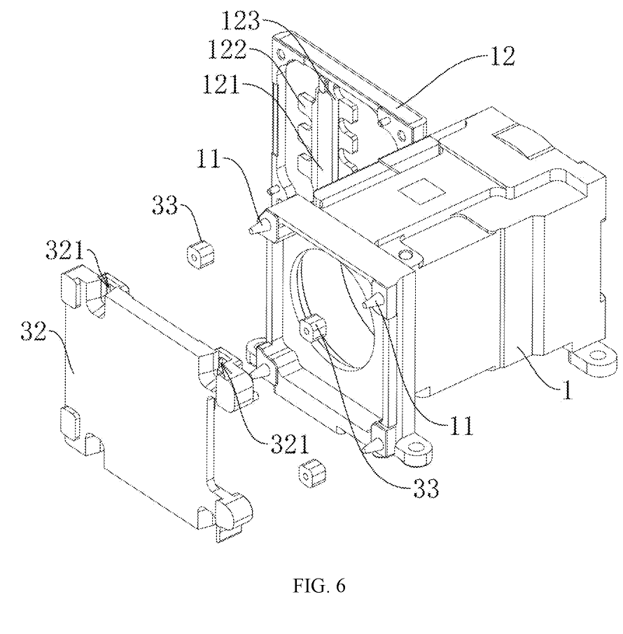

Regarding the positioning portion 11 and the positioning hole 321, please refer to FIG. 6. The quantity of the positioning portions 11, the positioning holes 321, and the adhesive members 33 is plural. The plurality of positioning portions 11 are arranged at intervals uniformly around the lens barrel 1. The plurality of positioning holes 321 are arranged at intervals uniformly around the structural member 32. The plurality of positioning portions 11 and the plurality of positioning holes 321 are inserted in one-to-one correspondence. One adhesive member 33 is filled between an inner wall of one positioning hole 321 and an outer wall of one corresponding positioning portion 11.

In the above manner, the stability between the optical module 3 and the lens barrel 1 can be improved.

Regarding the radar 100, please refer to FIGS. 3 -5. A side of the structural member 32 facing away from the optical component 31 is provided with a recess 322. The positioning hole 321 communicates with a bottom of the recess 322. A portion of the positioning portion 11 extending out of the positioning hole 321 along the first direction X is received in the recess 322. A portion of the adhesive member 33 extending out of the positioning hole 321 along the first direction X is filled between an inner wall of the recess 322 and an outer wall of the portion of the positioning portion 11 extending out of the positioning hole 321. The first direction X is a direction from the optical component 31 towards the structural member 32.

In the above manner, the height of the positioning portion 11 can be increased, thereby increasing the height of the adhesive member 33 filled between the positioning portion 11 and the positioning hole 321. This improves the stability between the positioning portion 11 and the positioning hole 321, and consequently enhances the stability between the optical module 3 and the lens barrel 1.

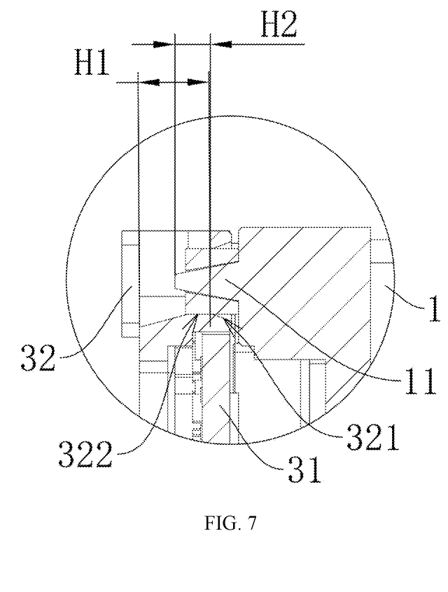

Regarding the recess 322, please refer to FIGS. 4 and 5, and also refer to FIG. 7. A depth of the recess 322 is greater than a height of the portion of the positioning portion 11 extending out of the positioning hole 321.

Specifically, defining the depth of the recess 322 as H1 and the height of the portion of the positioning portion 11 extending out of the positioning hole 321 as H2, then H1 > H2.

In the above manner, the volume of the recess 322 is greater than the volume of the portion of the adhesive member 33 received therein. This can prevent overflow of the adhesive member 33 before it solidifies and sets.

Regarding the recess 322, please refer to FIGS. 4 and 5. Along the first direction X, a cross-sectional area of at least a part of the recess 322 gradually increases. A cross-section of the recess 322 is a cross-section of the recess 322 along the second direction Y. The second direction Y is perpendicular to the first direction X.

Specifically, the recess 322 comprises a first groove section 3221 and a second groove section 3222. The first groove section 3221, the second groove section 3222, and the positioning hole 321 communicate sequentially. Along the first direction X, a cross-sectional area of the first groove section 3221 gradually increases. A cross-section of the first groove section 3221 is a cross-section of the first groove section 3221 along the second direction Y.

In the above manner, at least a part of the recess 322 is configured in a conical shape, which can increase the volume of the recess 322 so that it can receive a larger volume of adhesive member 33, reducing the probability of the adhesive member 33 overflowing before it solidifies.

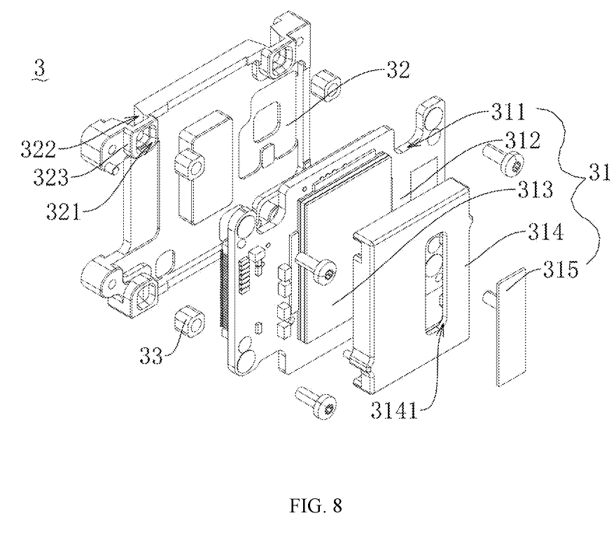

Regarding the radar 100, please refer to FIGS. 4 and 5, and also refer to FIG. 8. A side of the structural member 32 facing the lens barrel 1 is provided with a protruding portion 323. The positioning hole 321 penetrates the protruding portion 323. The optical component 31 is provided with an avoidance hole 311. The protruding portion 323 is inserted into the avoidance hole 311.

In the above manner, when the positioning hole 321 penetrates the protruding portion 323, the depth of the positioning hole 321 can be increased, thereby increasing the height of the adhesive member 33 filled between the positioning portion 11 and the positioning hole 321. This improves the stability between the positioning portion 11 and the positioning hole 321, and consequently enhances the stability between the optical module 3 and the lens barrel 1. Furthermore, when the protruding portion 323 is inserted into the avoidance hole 311, it not only provides a positioning function during the installation of the optical component 31 but also improves the stability between the optical component 31 and the structural member 32.

Regarding the optical component 31, please refer to FIG. 8. The optical component 31 comprises an optical mainboard 312, an optical chip 313, a light-shielding member 314, and a filter member 315. The optical mainboard 312 is disposed on the side of the structural member 32 facing the lens barrel 1. The optical chip 313 is disposed on a side of the optical mainboard 312 facing the lens barrel 1. The light-shielding member 314 is mounted to cover the optical chip 313. The light-shielding member 314 is provided with a light-transmitting hole 3141. The filter member 315 is disposed in the light-transmitting hole 3141. The avoidance hole 311 is provided in the optical mainboard 312.

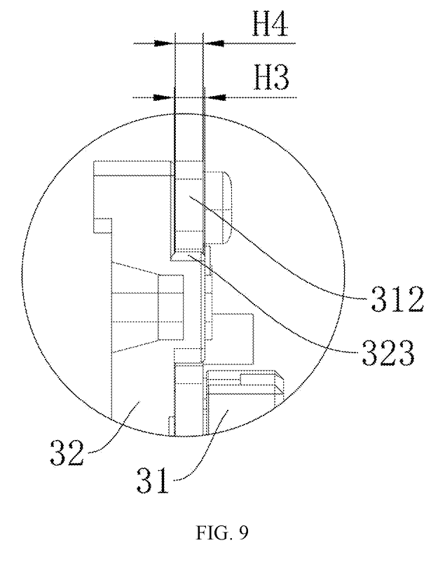

Regarding the optical component 31 and the structural member 32, please refer to FIGS. 8 and 9. A height of the protruding portion 323 is greater than a thickness of the optical mainboard 312.

Specifically, defining the height of the protruding portion 323 as H3 and the thickness of the optical mainboard 312 as H4, then H3 > H4.

In the above manner, the protruding portion 323 penetrates the avoidance hole 311. When the optical mainboard 312 is disposed on the side of the structural member 32 facing the lens barrel 1, the protruding portion 323 contacts the lens barrel 1 before the optical mainboard 312 does, thereby preventing the optical mainboard 312 from colliding with the lens barrel 1.

Regarding the radar 100, a material of the lens barrel 1 and a material of the structural member 32 are both metallic materials.

In the above manner, the materials of the lens barrel 1 and the structural member 32 are made the same, consequently making the materials of the positioning portion 11 and the positioning hole 321 the same. This ensures that the thermal expansion coefficient of the positioning portion 11 is the same as that of the positioning hole 321, avoiding thermal deformation caused by different thermal expansion coefficients, which could adversely affect the bonding firmness of the adhesive member 33.

Regarding the radar 100, please refer to FIG. 6. When the optical module is an emission optical module, this optical module comprises an emission board structural assembly 12. The emission board structural assembly 12 is provided with a light exit hole 121, a heat dissipation boss 122, and an isolation boss 123. The heat dissipation boss 122 is disposed surrounding the isolation boss 123. The isolation boss 123 is disposed surrounding the light exit hole 121. The optical module 3 comprises an emission chip (not shown). The emission chip is used to emit laser light which exits to the external environment through the light exit hole 121. The emission chip abuts against the heat dissipation boss 122. A thermally conductive layer (not shown) is disposed between the emission chip and the heat dissipation boss 122. The isolation boss 123 is disposed between the light exit hole 121 and the heat dissipation boss 122. A height of the isolation boss 123 is higher than that of the heat dissipation boss 122. The isolation boss 123 is used to prevent the thermally conductive layer from contaminating the light exit area of the light exit hole 121. The thermally conductive layer includes, but is not limited to, thermal gel.

To facilitate the reader's understanding of the concept of the embodiments of the present invention, an example of the specific installation method of the radar 100 is provided below:

First, install the optical component 31 onto the structural member 32. Then, use different clamps to hold the lens barrel 1 and the structural member 32 respectively. Control the movement of the structural member 32 to adjust its position until the optical module 3 is aligned with the emission module. At this point, the positioning portion 11 is received within the positioning hole 321. Subsequently, control a dispensing needle to extend into the recess 322 and dispense adhesive towards the space between the positioning hole 321 and the positioning portion 11 until a preset amount of adhesive is dispensed between the positioning hole 321 and the positioning portion 11. Then, retract the dispensing needle from the recess 322. Finally, control a UV irradiation lamp to extend into the recess 322 and irradiate the dispensed adhesive between the positioning hole 321 and the positioning portion 11 until a preset irradiation time is reached for the adhesive, allowing the adhesive to solidify and form the adhesive member 33. Then, retract the UV irradiation lamp from the recess 322.

An embodiment of the present invention provides a radar 100, comprising a lens barrel 1 and an optical module 3. The lens barrel 1 is provided with a positioning portion 11. The optical module 3 comprises an optical component 31, a structural member 32, and an adhesive member 33. The structural member 32 is provided with a positioning hole 321. The positioning portion 11 is inserted into the positioning hole 321. The adhesive member 33 is filled between an inner wall of the positioning hole 321 and an outer wall of the positioning portion 11. The adhesive member 33 fixedly adheres the inner wall of the positioning hole 321 and the outer wall of the positioning portion 11. The optical component 31 is disposed on a side of the structural member 32 facing the lens barrel 1. In the above manner, the cooperation between the positioning portion 11 and the positioning hole 321 in the embodiment of the present invention can facilitate active and precise positioning of the optical module 3 relative to the optical lens module disposed on the lens barrel 1 to complete optical alignment.

The present invention further provides an embodiment of a detection device. The detection device comprises the aforementioned radar 100. For the specific structure and functions of the aforementioned radar 100, reference may be made to the above embodiments, which will not be repeated here.

The above descriptions are merely specific embodiments of the present invention and are not intended to limit the patent scope of the present invention. Any equivalent structural or procedural transformations made based on the content of the specification and drawings of the present invention, or direct or indirect applications in other related technical fields, shall similarly be included within the patent protection scope of the present invention.

What is claimed is:

1. A radar, comprising:
a lens barrel, provided with a positioning portion; and
an optical module, comprising an optical component, a structural member, and an adhesive member,
wherein the structural member is provided with a positioning hole, the positioning portion is inserted into the positioning hole, the adhesive member is filled between an inner wall of the positioning hole and an outer wall of the positioning portion, the adhesive member fixedly adheres the inner wall of the positioning hole and the outer wall of the positioning portion, and the optical component is disposed on a side of the structural member facing the lens barrel.

2. The radar according to claim 1, wherein,
along a first direction, a cross-sectional area of the positioning portion gradually decreases, and a cross-section of the positioning portion is a cross-section of the positioning portion along a second direction;
wherein the first direction is a direction from the optical component towards the structural member, and the second direction is perpendicular to the first direction.

3. The radar according to claim 2, wherein,
along the first direction, a cross-sectional area of the positioning hole gradually decreases, and a cross-section of the positioning hole is a cross-section of the positioning hole along the second direction.

4. The radar according to claim 3, wherein,
along the first direction, the positioning portion has a first taper, the positioning hole has a second taper, and the first taper is equal to the second taper.

5. The radar according to claim 1, wherein,
a side of the structural member facing away from the optical component is provided with a recess, the positioning hole communicates with a bottom of the recess, and a portion of the positioning portion extending out of the positioning hole along the first direction is received in the recess;
wherein the first direction is a direction from the optical component towards the structural member.

6. The radar according to claim 5, wherein a depth of the recess is greater than a height of the portion of the positioning portion extending out of the positioning hole.

7. The radar according to claim 5, wherein,
along the first direction, a cross-sectional area of at least a part of the recess gradually increases, and a cross-section of the recess is a cross-section of the recess along the second direction, the second direction being perpendicular to the first direction.

8. The radar according to claim 7, wherein,
the recess comprises a first groove section and a second groove section, the first groove section, the second groove section, and the positioning hole communicate sequentially, and along the first direction, a cross-sectional area of the first groove section gradually increases, a cross-section of the first groove section being a cross-section of the first groove section along the second direction.

9. The radar according to claim 1, wherein,
the outer wall of the positioning portion is provided with a first laser-engraved surface, the first laser-engraved surface is provided with a plurality of first laser-engraved grooves, and one side of the adhesive member is at least partially embedded in the plurality of first laser-engraved grooves; and/or,
the inner wall of the positioning hole is provided with a second laser-engraved surface, the second laser-engraved surface is provided with a plurality of second laser-engraved grooves, and another side of the adhesive member is at least partially embedded in the plurality of second laser-engraved grooves.

10. The radar according to claim 1, wherein,
a side of the structural member facing the lens barrel is provided with a protruding portion, the positioning hole penetrates the protruding portion, the optical component is provided with an avoidance hole, and the protruding portion is inserted into the avoidance hole.

11. The radar according to claim 10, wherein,
the optical component comprises an optical mainboard, an optical chip, a light-shielding member, and a filter member, the optical mainboard is disposed on the side of the structural member facing the lens barrel, the optical chip is disposed on a side of the optical mainboard facing the lens barrel, the light-shielding member is mounted to cover the optical chip, the light-shielding member is provided with a light-transmitting hole, the filter member is disposed in the light-transmitting hole, and the avoidance hole is provided in the optical mainboard.

12. The radar according to claim 1, wherein a material of the lens barrel and a material of the structural member are both metallic materials.

13. A detection device, comprising the radar according to claims claim 1.
